(19) United States
(12) Patent Application Publication
(10) Pub. No.: US 2024/0289841 A1
(43) Pub. Date: Aug. 29, 2024

(54) IMMEDIATE LIVESTREAMS IN A SHORT-FORM VIDEO ECOMMERCE ENVIRONMENT

(71) Applicant: Loop Now Technologies, Inc., San Mateo, CA (US)

(72) Inventors: Edwin Chiu, Cupertino, CA (US); Michael A Shoss, Milton (CA)

(73) Assignee: Loop Now Technologies, Inc., San Mateo, CA (US)

(21) Appl. No.: 18/654,070

(22) Filed: May 3, 2024

Related U.S. Application Data
(63) Continuation-in-part of application No. 18/585,212, filed on Feb. 23, 2024.
(60) Provisional application No. 63/571,732, filed on Mar. 29, 2024.
(60) Provisional application No. 63/557,622, filed on Feb. 26, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/638,476, filed on Apr. 25, 2024.

(51) Int. Cl. G06Q 30/0251; G06Q 30/0241; G06Q 30/0601

(52) U.S. Cl. CPC G06Q 30/0255; G06Q 30/0277; G06Q 30/0633

(57) ABSTRACT

Disclosed embodiments provide techniques for immediate livestreams in a short-form video ecommerce environment. A website that includes a plurality of products for sale is accessed. The website is viewed by a plurality of users. One or more groups of users is identified. Each of the one or more groups includes users with an interest in one or more products from the plurality of products for sale. An immediate livestream is created for each group of the one or more groups of users when a number of users within each group is higher than a threshold value. The immediate livestream includes the one or more products. The immediate livestream is rendered within the container unit on the website to each group of the one or more groups of users. An ecommerce purchase of the one or more products is enabled within the immediate livestream.

### RELATED APPLICATIONS

This application claims the benefit of U.S. provisional patent applications “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, “Artificial Intelligence Virtual Assistant Using Staged Large Language Models” Ser. No. 63/571,732, filed Mar. 29, 2024, and “Artificial Intelligence Virtual Assistant In A Physical Store” Ser. No. 63/638,476, filed Apr. 25, 2024.

This application is also a continuation-in-part of U.S. patent application “Synthesized Realistic Metahuman Short-Form Video” Ser. No. 18/585,212, filed Feb. 23, 2024, which claims the benefit of U.S. provisional patent applications “Synthesized Realistic Metahuman Short-Form Video” Ser. No. 63/447,925, filed Feb. 24, 2023, “Dynamic Synthetic Video Chat Agent Replacement” Ser. No. 63/447,918, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, and “Artificial Intelligence Virtual Assistant Using Large Language Model Processing” Ser. No. 63/613,312, filed Dec. 21, 2023.

Each of the foregoing applications is hereby incorporated by reference in its entirety.

### FIELD OF ART

This application relates generally to video creation and more particularly to immediate livestreams in a short-form video ecommerce environment.

### BACKGROUND

Marketing and advertising have been part of society for as long as goods and services have been offered for sale. Promoting a product to potential buyers has become an art form of its own. In earlier times, as far back as 5000 BC, symbols, words, and images were used to identify artisans and manufacturers of goods so that users would know where an object had come from, and where and from whom one might obtain more. This practice eventually led to trademarks such as those in use today. The purpose of the mark remains the same: to identify the maker or distributor of a product, and by extension, tell the user how to obtain more information and more products. Some symbols were also used as signs, advertising where a particular trade or craft was practiced. Barber poles, for example, were used in 17^{th} century Europe to denote the place where people could get their hair trimmed and faces shaved. Signage is one of the oldest forms of communication in general, as well as a means to advertise goods and services. Signs such as visual graphics and storytelling pictographs have been found in caves dating back to 18,000 BC. Modern visual signs started in Greek, Roman, and Egyptian cities around 3000 BC. They were normally made of carved stone or wood, or were formed of terra cotta. Since the majority of the population was illiterate, the signs generally included images rather than text. As trade and commerce increased, signs became more elaborate and decorative. Bright paints, ornamental iron work, and gilding were used by merchants to attract buyers and compete with other vendors.

Verbal and musical advertising was also used. Town criers announced news, legal declarations, and important events. Advertising goods and services followed the same path, from newspaper boys calling out headlines from street corners, to shop owners shouting out to customers from windows or front doors. Carnival barkers enticed passersby to try their luck at various games or pay to see a show. Carts loaded with bread, fruits, or meats were wheeled down avenues as the vendor shouted or sang out their location and sold their wares. As education and technology became more widespread, printed advertising became more widely used. Signs and placards could be posted on the street, in windows, and in town squares directing customers to shops and other places of business. Newspapers and magazines began to include advertising to help pay the cost of production and promote businesses that helped to sponsor sales events, entertainment, and so on.

The modern computer age and digital communications have only added to the advertising and marketing efforts of manufacturers and vendors. Indeed, many of the largest companies on the Internet make much of their income from advertising goods and services. Electronic billboards can be placed on nearly any website and can be customized to the needs of specific groups of buyers. Most electronic advertising includes hypertext or other forms of text and links which allow a user, with a simple click of a mouse or tap of a finger, to go to a specific website designed to sell products. As cellphones have improved, buyers can purchase products as they travel, sit in traffic, or lounge on a park bench. Ecommerce sites include details of items for sale from across the globe. Shipping details, sizes, colors, patterns, pricing, quantities, and so on can be selected, payment can be made, and the progress of one's order can be tracked all while the consumer is watching TV or working at a desk. As the world becomes increasingly interconnected and access to digital platforms continues to explode, marketing and advertising of products will only continue to advance and thrive as more and more items and services become available.

### SUMMARY

Techniques for immediate livestreams in a short-form video ecommerce environment are disclosed. Online marketing and advertising of products and services continues to grow and is being better targeted to specific sectors of the consumer population. Ecommerce customers have become more sophisticated and selective in the ways in which they acquire information about products. Their expectations mirror the requirements of customers in a physical high-end boutique store. They look for customized service from a knowledgeable individual or group. One-on-one and small group interactions with web hosts, influencers, product experts, or celebrities have greater impact and result in higher profits. Participating in real-time events that demonstrate products and services, joined to interactions with other like-minded customers, encourages longer online time on websites and can result in higher sales.

Disclosed embodiments provide techniques for immediate livestreams in a short-form video ecommerce environment. A website that includes a plurality of products for sale is accessed. The website is viewed by a plurality of users. One or more groups of users are identified. Each of the one or more groups includes users with an interest in one or more products from the plurality of products for sale. An immediate livestream is created for each group of the one or more groups of users when a number of users within each group is higher than a threshold value. The immediate livestream includes the one or more products. The immediate livestream is rendered within the container unit on the website to each group of the one or more groups of users. An ecommerce purchase of the one or more products is enabled within the immediate livestream.

A computer-implemented method for video creation is disclosed comprising: accessing a website, wherein the website includes a plurality of products for sale, wherein the website includes a container unit comprising one or more short-form videos, and wherein the website is viewed by a plurality of users; identifying one or more groups of users from the plurality of users, wherein each of the one or more groups includes users with an interest in one or more products from the plurality of products for sale; creating, for each group of the one or more groups of users, an immediate livestream, wherein a number of users within each group is higher than a threshold value, and wherein the immediate livestream includes the one or more products; rendering, to each group of the one or more groups of users, the immediate livestream within the container unit on the website; and enabling, within the immediate livestream that was rendered, an ecommerce purchase of the one or more products. In embodiments, the identifying is based on a trigger event. In embodiments, the trigger event includes watching, by the one or more groups of users, at least one short-form video related to the one or more products. In embodiments, the trigger event includes placing, by the one or more groups of users, the one or more products into a virtual cart. In embodiments, the trigger event includes spending a length of time on a webpage within the website by the one or more groups of users. And in embodiments, the trigger event includes viewing a comparison of at least two products for sale by the one or more groups of users.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for immediate livestreams in a short-form video ecommerce environment.

FIG. 2 is a flow diagram for an ecommerce purchase in an immediate livestream.

FIG. 3 is an infographic for immediate livestreams in a short-form video ecommerce environment.

FIG. 4 is an infographic of a container unit.

FIG. 5 illustrates editing an immediate livestream.

FIG. 6 is an example of an ecommerce environment.

FIG. 7 is a system diagram for immediate livestreams in a short-form video ecommerce environment.

### DETAILED DESCRIPTION

Short-form videos are changing how consumers gather information about and purchase products and services. As people become more electronically connected and comfortable with digital technologies, the opportunities to inform and persuade customers continue to move to multi-media methods. Companies and individuals produce short-form videos using many different formats and approaches, demonstrating the use of products and related services, comparing their products to competitors, etc. In some cases, endorsements by web influencers, celebrities, and product experts are included, as well as instructional videos detailing the uses of products in particular applications. Once created, these digital videos can be edited rapidly and distributed even more quickly. Using various social media and ecommerce platforms, consumers can comment on their experiences with products and companies and share them with others. In many cases, these comments often take the form of short-form videos, expanding the number of videos available to help sell goods and services. Purchases which have no in-person interactions with sales representatives or even the products themselves have become commonplace. Now customers make purchase decisions based on information gathered electronically through ecommerce websites, social media outlets, or video websites. Livestream events only add to the digital sales opportunities. Livestreams give customers the opportunity to interact with product experts, celebrity hosts, influencers, and other interested consumers as they make purchases in real time. Thus, managing and associating products and services with targeted short-form videos and distributing them rapidly to potential buyers are vital to thrive in today's commercial environment.

Techniques for immediate livestreams in a short-form video ecommerce environment are disclosed. First, an ecommerce website is accessed. The website offers products for sale, a library of short-form videos related to the products, and many ecommerce customers. As customers peruse the ecommerce website, their actions are tracked and categorized by an AI machine learning model. The model looks for groups of users who show interest in particular products and product categories. Customer interest can be indicated in many ways: selecting short-form videos from the ecommerce video library, selecting items to purchase, asking questions about products on the site's help page, staying on a particular product page for a longer length of time, and so on. As the AI model identifies groups of users interested in a specific product or group of related products, a livestream event can be automatically generated. The livestream event can be quickly set up in real time and designed to highlight and sell the product or products associated with the customer group identified by the AI model. As the livestream is built, a sales representative for the ecommerce website is notified. The sales representative becomes the host for the livestream event. Prior to the beginning of the livestream event, the sales representative can access a back-end view of the livestream, including the list of products selected for sale. The sales representative can add to the list of products by selecting associated items from the list of products offered by the ecommerce site. The salesperson can also make changes to the livestream look and feel, block sites that may lead the customers away from the livestream, and so on. Further, the salesperson can schedule the beginning of the livestream and notify all of the customers in the group about the livestream, inviting them to attend and including a click button to join. The livestream includes an ecommerce environment, allowing the customers to make purchases as the livestream occurs. An interactive overlay is included in the livestream as well, allowing customers to interact with one another and the livestream host, ask questions, make comments, respond to multiple choice chats, and so on. As more ecommerce customers interact with the website, multiple livestream events can be generated and hosted by sales representatives. The sales representatives can host the site using a mobile device or a demonstration room equipped with products from the ecommerce site. The benefits of this include immediate responses to customer interest in products or services in the form of livestream events that engage the users, directly involve knowledgeable sales representatives, and increase product sales.

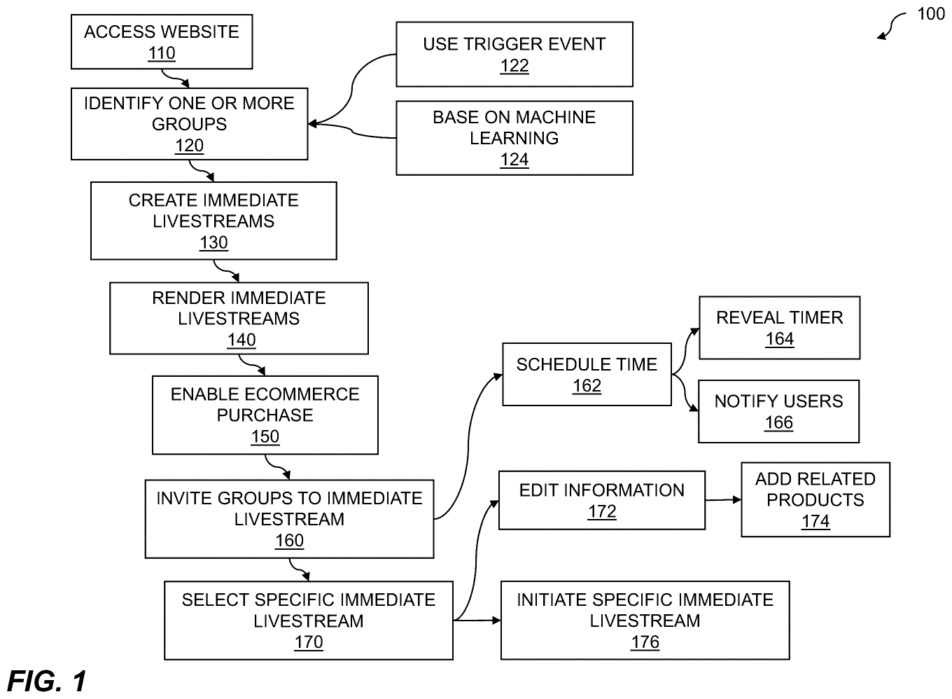

FIG. 1 is a flow diagram 100 for immediate livestreams in a short-form video ecommerce environment. The flow 100 includes accessing a website 110, wherein the website includes a plurality of products for sale, wherein the website includes a container unit comprising one or more short-form videos, and wherein the website is viewed by a plurality of users. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser or another application running on the device. The container unit comprises a story block, carousel, floating player, or grid. A container unit is a component of a web server that interacts with computer programs, called servlets, that are designed to interact with users, other programs, or other servers. The container unit manages the lifecycle of the servlets, maps URLs to particular servlets, confirms access rights to URLs, and so on. Story blocks are servlets that access stock-published video footage, templates, music, and/or photo content available for download from websites or libraries of short-form videos. A carousel is a set of related containers within a primary container, each populated by a single related short-form video. A carousel container allows multiple videos selected by the user to be placed on the website in order of selection. A floating player is a video player that runs entirely within the container unit without affecting the displayed main webpage. The container unit “floats” on top of the host website page so that no format or content disruption occurs. A grid container allows videos to be placed in specific locations within the container using standardized row and column references. Additional information, including header information, color schemes, company logos, etc., can also be placed into the container unit in specific locations. The container unit can be populated by the at least one selected short-form video from the website. In embodiments, the populating of the container unit can be accomplished dynamically. Dynamic populating allows the container unit generated on the website to play or change the one or more selected short-form videos without refreshing the website page.

The flow 100 includes identifying one or more groups of users 120 from the plurality of users, wherein each of the one or more groups includes users with an interest in one or more products from the plurality of products for sale. In embodiments, the identifying is based on a trigger event 122. A trigger event is an action or occurrence on a website that can indicate user interest in the contents of a webpage or in products displayed on a webpage. The trigger events can include watching, by the one or more groups of users, at least one short-form video related to the one or more products; placing, by the one or more groups of users, the one or more products into a virtual cart; spending a length of time on a webpage within the website by the one or more users; viewing a comparison of at least two products for sale by the one or more groups of users; and so on. Additional trigger events can include scrolling to the bottom or end of a webpage, clicks leading to associated webpages, questions or comments made by users regarding a product or brand, website searches for related products, and so on. Further additional trigger events can include when a certain number of people are looking at a page of the website or a category of the website; when an item being added to a cart in the last x seconds (where x is a consideration time, such as 30 s) and when n other users also have it in their cart (where n is a threshold of interest that can vary widely depending on the product type and product sales history); and when an item is abandoned in a cart. When an item is abandoned in a cart, for example, a livestream and/or showroom can be scheduled in 24 hours and an email alert sent to the shopper who abandoned the item.

As each trigger event is recorded, metadata associated with the user generating the trigger event can also be collected, including hashtags, purchase history, favorites, and so on. The metadata can also include demographic information. In some embodiments, the trigger events can be weighted so that some events are more significant in the creation of user groups than others. For instance, clicks on specific products can be given a higher weight than general questions about a product brand or broad category of products. The trigger event and user data can be submitted to a database that can be accessed by a machine learning model.

In embodiments, the identifying of user groups with interests in one or more products is based on machine learning 124. Machine learning models can be used to cluster or separate data points into a number of groups so that data points in the same group are more similar to other data points in the same group and dissimilar to the data points in other groups. For example, users who generate trigger events on a website related to lipstick can be grouped together. A user who generates trigger events only related to bicycles would not be included in the same group. There are several machine learning algorithms available to evaluate data points and generate groups of users with similar trigger events, including K-means; DBSCAN; Gaussian mixture; Balance Iterative, Reducing and Clustering using Hierarchies (BIRCH); affinity propagation; and so on. The result of using the machine learning model clustering algorithms is that groups of viewers on the website in which each group is interested in the same product, type of product, or brand can be identified. These groups can be used as the basis for creating an immediate livestream that can offer the associated products for sale to the users in the associated group.

The flow 100 includes creating, for each group of the one or more groups of users, an immediate livestream 130, wherein a number of users within each group is higher than a threshold value, and wherein the immediate livestream includes the one or more products. A livestream is a streaming media event that is simultaneously recorded and broadcast in real time over the Internet. It can include audio, video, or both at the same time. Livestreaming can include a wide variety of topics, including sporting events, sales events, video games, artistic performances, marketing campaigns, political speeches, advertising presentations, and so on. Once recorded, the livestream event can be replayed and expanded upon as viewers comment and interact with the replay of the livestream event in real time. In embodiments, the livestream can be generated immediately, based on an identified group of website users that show common interest in a product, products, or brand included on a website. The threshold value for the number of users required to initiate the creation of an immediate livestream is programmable. The immediate livestream 130 can be created with the one or more products associated with the user group available for purchase during the livestream event. The creating includes connecting a host to the livestream. In embodiments, the immediate livestream host can be a sales associate of the website. The immediate livestream host can be a synthetic host, created by artificial intelligence algorithms. The creating includes notifying the host of the immediate livestream. The sales associate can be someone who is knowledgeable about the one or more products, a member of the ecommerce website staff, an employee or owner of an associated store in a physical location, an employee or owner of an online store, a third-party salesperson, and so on. The notification can be accomplished by text to a chat application, email, voicemail, electronic messages to an application running on a mobile device, etc.

The flow 100 includes rendering, to each group of the one or more groups of users, the immediate livestream 140 within the container unit on the website. The rendering can include displaying decoded video frames on an electronic display, such as a screen of a smartphone or tablet, laptop or desktop computer, PDA, and so on. The immediate livestream can be rendered outside of the container unit on the website or can be rendered to occupy the entire screen. The short-form video can be delivered from a web server hosting the ecommerce website. The delivery can be via any suitable network protocols, including, but not limited to, TCP, UDP, HTTP Live Streaming (HLS), Real-Time Messaging Protocol (RTMP), Web Real-Time Communications (WebRTC), Secure Reliable Transport (SRT), and/or other suitable protocols. The livestream can be delivered via unicast, multicast, or broadcast. In many cases, multicast is considered a one-to-many and many-to-many communication protocol that reduces network traffic when transmitting large amounts of data. Bandwidth optimization can occur because it delivers one single version of a data file, such as a livestream, to hundreds or thousands of users simultaneously. In embodiments, the rendering can begin before each group joins the livestream. Thus, in embodiments, the flow 100 further comprises inviting each group of the one or more groups of users to participate in the immediate livestream that was created. This inviting can occur after the immediate livestream is rendered.

In embodiments, the immediate livestream includes an interactive overlay. The interactive overlay can include a multiple-choice selection, a call to action, a lead generation prompt, a question card, a poll, and so on. A call to action (CTA) is an invitation to a website user to perform a desired action. For instance, a short question such as, “Would you like to know more?” can be accompanied by a button that takes the user to another webpage or starts a short-form video. A lead generation prompt includes a small set of questions for a user to allow a sales representative to follow up with additional information regarding a product or service.

For instance, the user's first and last name, phone number, email address, and/or best times to contact can make up a typical lead generation prompt. User responses to questions or comments appearing in the interactive overlay can be recorded; choices of additional short-form videos can be presented and selected; options to purchase products or services portrayed in the video can be chosen; options to replay a short-form video, go back to a previous video, or stop watching videos can be selected; and so on. The interactions can be forwarded to the machine learning model in order to learn and update associations to one or more products made by users. As described in later steps, an ecommerce environment can be rendered with the interactive overlay so that the user can select items to be purchased immediately or at a later time.

In embodiments, the immediate livestream includes highlighting the one or more products for sale to the user. The host can demonstrate, endorse, recommend, and otherwise interact with one or more products for sale as the livestream plays. The host can also respond to questions and comments made by users through the interactive overlay. An ecommerce purchase of at least one product for sale can be enabled to the viewer, wherein the ecommerce purchase is accomplished within the livestream window.

The flow 100 includes enabling, within the immediate livestream that was rendered, an ecommerce purchase 150 of the one or more products. As mentioned above and throughout, the livestream host can highlight products and services for sale during the livestream event. The host can demonstrate, endorse, recommend, and otherwise interact with one or more products for sale. An ecommerce purchase of at least one product for sale can be enabled to the viewer, wherein the ecommerce purchase is accomplished within the livestream window. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale can be revealed, wherein the revealing is rendered to the viewer. The viewer can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

The flow 100 further comprises inviting each group 160 of the one or more groups of users to participate in the immediate livestream that was created. In embodiments, the invitation can be accomplished by text chat, video chat, email, voicemail, or instant messaging. The invitation can be rendered directly to a browser on a mobile device or to a separate application. The invitation can be rendered to the host website page or sent to separate applications including email and chat applications running separately on the user mobile device. The invitation is sent to all members of the group identified by the machine learning model, wherein all members of the group demonstrate interest in the same product, product type, or brand sold on the host website. In embodiments, the inviting further comprises scheduling a time 162 for the immediate livestream to begin. The scheduling can be accomplished by the sales associate acting as the host of the immediate livestream. The scheduling can be set using back-office access to the host website. The inviting further comprises notifying users 166 within each group of the one or more groups of the time for the immediate livestream to begin. After the scheduled time for launching the immediate livestream is selected by the sales associate, the start time can be forwarded to the user group using text, video chat, email, voicemail, etc. The inviting further comprises revealing a countdown timer 164 as an overlay to the immediate livestream prior to the start of the immediate livestream. The countdown timer can be rendered to the user browser or to a separate application running on the user mobile device. The countdown timer can include options for how the user is to be notified once the livestream begins, whether or not to automatically begin the livestream on the user device, forwarding the notification to additional users, and so on.

The flow 100 further comprises selecting, by a sales associate, a specific livestream 170 from a list of the immediate livestreams that were created for each group of the one or more groups of users. The sales associate can be someone who is knowledgeable about the one or more products, a member of the ecommerce website staff, an employee or owner of an associated store in a physical location, an employee or owner of an online store, a third-party salesperson, and so on. The sales associate can be notified about the immediate livestream by text to a chat application, email, voicemail, or electronic message to an application running on a mobile device. The sales associate can access the host website using a mobile device or another internet-connected television (CTV) viewer including a smart TV which can be directly attached to the Internet; a television connected to the Internet via a cable box, TV stick, or game console; an Over-the-Top (OTT) device such as a laptop computer, tablet, pad, or desktop computer; etc. In embodiments, the accessing the website on the device can be accomplished using a browser or another application running on the device.

In embodiments, the selecting further comprises editing 172, by the sales associate, information pertaining to the specific livestream. The sales associate can display the list of products associated with the group of users identified by the machine learning model and can adjust the list based on similar products in the same category, items from the same manufacturer, items associated with the same brand, and so on. The sales associate can add, to the immediate livestream, other products for sale 174 related to the one or more products for sale. The machine learning model can record the additional items to its database so that the related products are made available to sales associates in additional immediate livestreams generated by the website. The immediate livestream selection further comprises initiating, by the sales associate, the specific immediate livestream 176. The initiating can be preceded by scheduling the beginning of the livestream event, notifying the users, and adding a countdown timer to the website or user group's browsers so that they are aware of the scheduled start time. The initiating renders the livestream session, including the ecommerce environment and the interactive overlay, so that users can purchase products and interact with the host and other users as the livestream plays.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

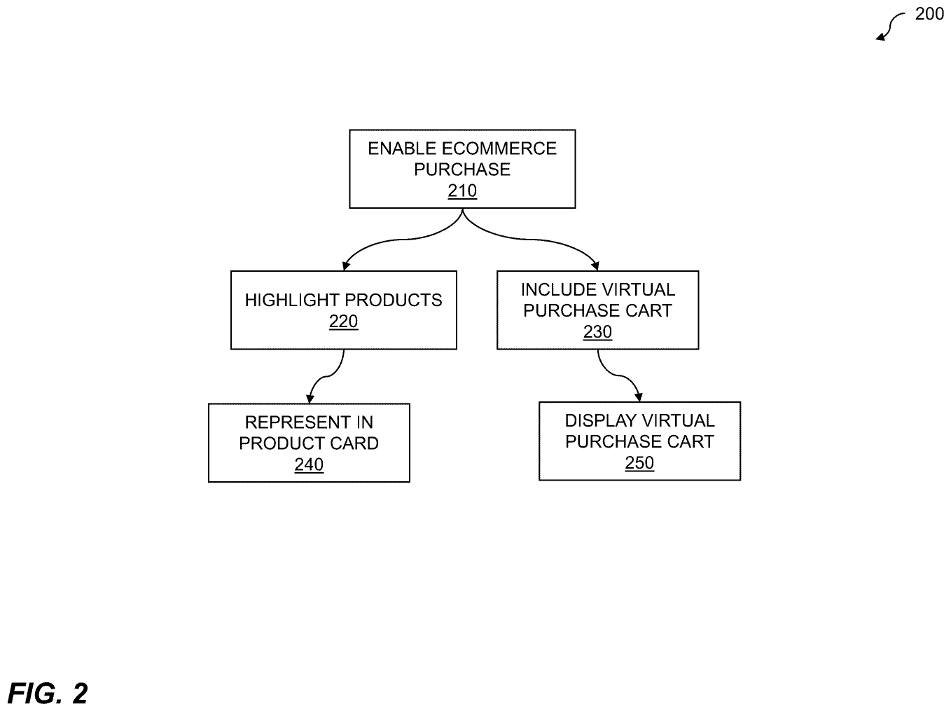

FIG. 2 is a flow diagram 200 for an ecommerce purchase in an immediate livestream. As mentioned above and throughout, an ecommerce website that includes one or more products for sale, a library of short-form videos associated with the one or more products for sale, and one or more viewers accessing the website can be accessed. As the users view web pages and products on the website, multiple trigger events are generated by the users, including time spent on specific web pages, products placed in virtual shopping carts, questions and comments about products or brands, short-form videos viewed, and so on. The trigger events are recorded and analyzed by a machine learning model. The machine learning model uses algorithms to identify groups of users with similar interests in specific products, product categories, brands, etc. A threshold of numbers of users in a group can be set and used to trigger the generation of an immediate livestream. The immediate livestream includes a list of products associated with the group identified by the machine learning model, an ecommerce environment to allow purchases of products and services, and an interactive overlay so that users in the group can interact with one another and the livestream host as it plays. Sales associates on the ecommerce website are notified as the immediate livestreams are created. The sales associate can select a specific immediate livestream and serve as the livestream host. The sales associate can review and adjust the products for sale on the livestream prior to its being rendered to the user group. The sales associate can schedule the start time of the livestream, notify the users in the associated group, and set up a countdown clock to prepare the users for the start of the livestream event.

The flow 200 includes enabling, within the immediate livestream that was rendered, an ecommerce purchase 210 of the one or more products. In embodiments, the ecommerce purchase environment includes product price, shipping price, and shipping method information from the ecommerce website. The immediate livestream can be linked to the host company's main website, allowing the website ecommerce platform to manage product sales, information, shipping, and so on. Website user requests for additional product information can also be fulfilled by the primary website. The catalog of products for sale is a subset of those offered by the primary host company, as is the ecommerce infrastructure, so that the technical resources required to process sales and deliver the products need not be recreated for each immediate livestream event.

The flow 200 includes highlighting the one or more products 220 for sale to the user. In embodiments, the livestream host can highlight products and services for sale during the livestream event. The host can demonstrate, endorse, recommend, and otherwise interact with one or more products for sale. The host can also interact with one or more users in the group, responding to questions and comments, supplying additional information, showing short-form videos, generating multiple-choice queries, and so on. An ecommerce purchase of at least one product for sale can be enabled to the user, wherein the ecommerce purchase is accomplished within the livestream window. As the host interacts with and presents the products for sale, a product card 240 can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale are revealed, wherein the revealing is rendered to the viewer.

The flow 200 includes a virtual purchase cart 230 as part of the enabling of ecommerce purchases 210. In embodiments, the enabling includes displaying 250, within the immediate livestream, the virtual purchase cart. The ecommerce purchase 210 includes selecting, by the user, the one or more products for sale, and displaying a product details page in response to a user action, such as clicking on a product card. The rendering enables an ecommerce purchase, within the ecommerce environment, of the one or more products that were selected by the user. In embodiments, the displaying of the virtual purchase cart can cover a portion of the immediate livestream. The interactive overlay includes an ability for the user to clip coupons; choose from multiple related products; and update quantity, price, size, color, or other variable aspects of a product. The enabling further comprises completing checkout from the virtual purchase cart.

The flow 200 includes representing the one or more products for sale in an on-screen product card 240. In embodiments, the product card represents at least one product available for purchase while the immediate livestream plays. Embodiments can include inserting a representation of a product for sale into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action.

The product card can be inserted when the livestream is visible in the livestream event. When the product card is invoked, an in-frame shopping environment is rendered over a portion of the video while the video continues to play. This rendering enables an ecommerce purchase by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

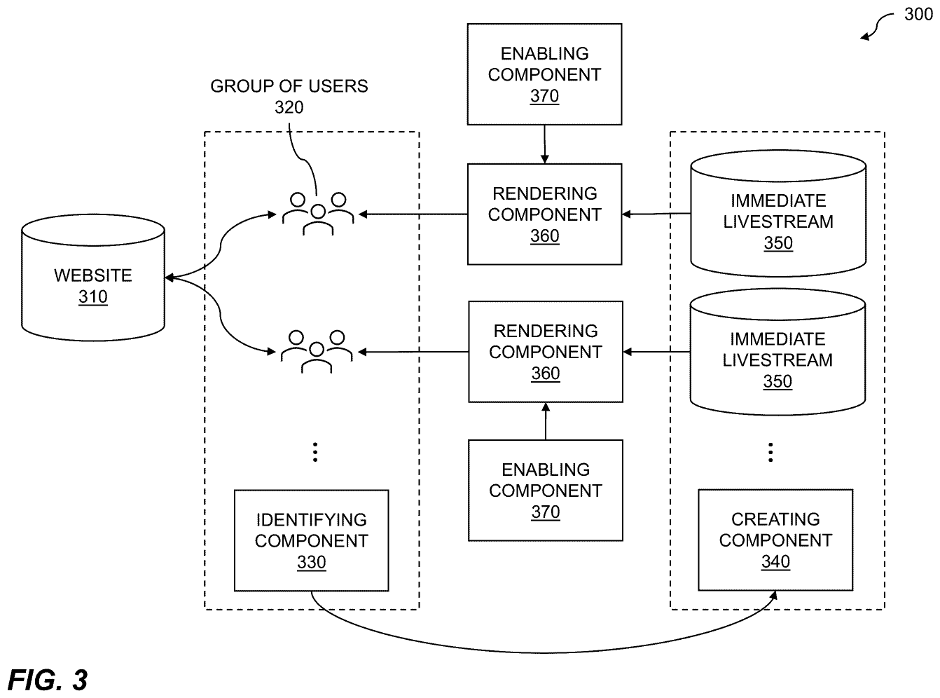

FIG. 3 is an infographic for immediate livestreams in a short-form video ecommerce environment. The infographic 300 includes accessing a website 310, wherein the website includes a plurality of products for sale, wherein the website includes a container unit comprising one or more short-form videos, and wherein the website is viewed by a plurality of users. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. In some embodiments, the accessing can be accomplished using another connected television (CTV), such as a smart TV, or a television connected to the Internet via a cable box, TV stick, or game console. The accessing of the website can be accomplished using a browser or another application running on the device.

In embodiments, the container unit comprises a story block, carousel, floating player, or grid. A container unit is a component of a web server that interacts with computer programs, called servlets, that are designed to interact with users, other programs, or other servers. The container unit manages the lifecycle of the servlets, maps URLs to particular servlets, confirms access rights to URLs, and so on. Story blocks are servlets that access stock-published video footage, templates, music, and/or photo content available for download from websites or libraries of short-form videos. A carousel is a set of related containers within a primary container, each populated by a single related short-form video. A carousel container allows multiple videos selected by the user to be placed on the website in order of selection. A floating player is a video player that runs entirely within the container unit without affecting the displayed main webpage. The container unit “floats” on top of the host website page so that no format or content disruption occurs. A grid container allows videos to be placed in specific locations within the container using standardized row and column references. Additional information, including header information, color schemes, company logos, etc., can also be placed into the container unit in specific locations. The container unit can be populated by the at least one selected short-form video from the website. In embodiments, the populating of the container unit can be accomplished dynamically. Dynamic populating allows the container unit generated on the website to play or change the one or more selected short-form videos without refreshing the website page.

The infographic 300 includes an identifying component 330. The identifying component 330 includes identifying one or more groups of users 320 from the plurality of users, wherein each of the one or more groups includes users with an interest in one or more products from the plurality of products for sale. In embodiments, the identifying is based on a trigger event, wherein the trigger event includes watching, by the one or more groups of users, at least one short-form video related to the one or more products; wherein the trigger event includes placing, by the one or more groups of users, the one or more products into a virtual cart; wherein the trigger event includes spending a length of time on a webpage within the website by the one or more groups of users; and wherein the trigger event includes viewing a comparison of at least two products for sale by the one or more groups of users. Trigger events can be any recordable action taken by a user on a website that can indicate an interest in a product, product category, or brand. Additional trigger events can include scrolling to the bottom or end of a webpage, clicks leading to associated webpages, questions or comments made by users regarding a product or brand, website searches for related products, and so on. As each trigger event is recorded, metadata, including hashtags, purchase history, favorites, and so on associated with the user generating the trigger event, can also be collected. The metadata can further include demographic information. In some embodiments, the trigger events can be weighted so that some events are more significant in the creation of user groups than others. For instance, clicks on specific products can be given a higher weight than general questions about a product brand or broad category of products. The trigger event and user data can be submitted to a database that can be accessed by a machine learning model.

In embodiments, the identifying is based on machine learning. Machine learning models can be used to cluster or separate data points into a number of groups so that data points in the same group are more similar to other data points in the same group and dissimilar to the data points in other groups. For example, users who generate trigger events on a website related to lipstick can be grouped together. Another user who generates trigger events related only to bicycles would not be included in the same group. There are several machine learning algorithms available to evaluate data points and generate groups of users with similar trigger events, including K-means; DBSCAN, Gaussian mixture; Balance Iterative, Reducing and Clustering using Hierarchies (BIRCH); affinity propagation; and so on. The result of using the machine learning model clustering algorithms is to identify groups of viewers on the website in which each group is interested in the same product, type of product, or brand. These groups can be used as the basis for creating an immediate livestream 350 that can offer the associated products for sale to the users in the associated group.

The infographic 300 includes a creating component 340. The creating component 340 includes creating, for each group of the one or more groups of users, an immediate livestream 350, wherein a number of users within each group is higher than a threshold value, and wherein the immediate livestream 350 includes the one or more products. A livestream is a streaming media event that is simultaneously recorded and broadcast in real time over the Internet. It can include audio, video, or both at the same time. Livestreaming can include a wide variety of topics, including sporting events, sales events, video games, artistic performances, marketing campaigns, political speeches, advertising presentations, and so on. Once recorded, the livestream event can be replayed and expanded upon as viewers comment and interact with the replay of the livestream event in real time. In embodiments, the livestream can be generated immediately, based on a group of website users identified by a machine learning model that show common interest in a product, products, or brand included on a website. The number of users in the identified group must be higher than a threshold value. In embodiments, the threshold value is programmable. The immediate livestream 350 can be created with the one or more products associated with the user group and made available for purchase during the livestream event.

In embodiments, one or more immediate livestreams can be created by the creating component and rendered to the associated group of users simultaneously as groups of users with common interests in products, types of products, or brands are identified by the machine learning model. The one or more livestreams can be created once each group of users identified by the machine learning model contains more users than a programmable threshold value.

The infographic 300 includes a rendering component 360. The rendering component 360 includes rendering, to each group of the one or more groups of users, the immediate livestream 350 within the container unit on the website 310. The rendering can include displaying decoded video frames on an electronic display, such as a screen of a smartphone or tablet, laptop or desktop computer, PDA, and so on. The immediate livestream can be rendered outside of the container unit on the website or can be rendered to occupy the entire screen. The immediate livestream can be delivered from a web server hosting the ecommerce website. The delivery can be via any suitable network protocols, including, but not limited to, TCP, UDP, HTTP Live Streaming (HLS), Real-Time Messaging Protocol (RTMP), Web Real-Time Communications (WebRTC), Secure Reliable Transport (SRT), and/or other suitable protocols. The livestream can be delivered via unicast, multicast, or broadcast. In many cases, multicast is considered a one-to-many and many-to-many communication protocol that reduces network traffic when transmitting large amounts of data. Bandwidth optimization can occur because it delivers one single version of a data file, such as a livestream, to hundreds or thousands of users simultaneously.

In embodiments, the immediate livestream 350 includes an interactive overlay. The interactive overlay can include a multiple-choice selection, a call to action, a lead generation prompt, a question card, a poll, and so on. A call to action (CTA) is an invitation to a website user to perform a desired action. For instance, a short question such as, “Would you like to know more?” can be accompanied by a button that takes the user to another webpage or starts a short-form video. A lead generation prompt includes a small set of questions for a user to allow a sales representative to follow up with additional information regarding a product or service. For instance, the user's first and last name, phone number, email address, and/or best times to contact can make up a typical lead generation prompt. User responses to questions or comments appearing in the interactive overlay can be recorded; choices of additional short-form videos can be presented and selected; options to purchase products or services portrayed in the video can be chosen; options to replay a short-form video, go back to a previous video, or stop watching videos can be selected; and so on. The interactions can be forwarded to the machine learning model in order to learn and update associations to one or more products made by users. As described in later steps, an ecommerce environment can be rendered with the interactive overlay so that the user can select items to be purchased immediately or at a later time.

The infographic 300 includes an enabling component 370. The enabling component 370 includes enabling, within the immediate livestream that was rendered, an ecommerce purchase of the one or more products. In embodiments, the immediate livestream 350 includes highlighting the one or more products for sale to the user. The highlighting further comprises representing the one or more products for sale in an on-screen product card. The enabling the ecommerce purchase includes a virtual purchase cart. The enabling further comprises displaying within the immediate livestream 350, the virtual purchase cart, wherein the virtual purchase cart covers a portion of the immediate livestream. As mentioned above and throughout, the livestream host can highlight products and services for sale during the livestream event. The host can demonstrate, endorse, recommend, and otherwise interact with one or more products for sale. An ecommerce purchase of at least one product for sale can be enabled to the group of users, wherein the ecommerce purchase is accomplished within the livestream window. As the sales associate host interacts with and presents the products for sale, a product card can be included within a livestream shopping window. An ecommerce environment associated with the livestream event can be generated on the viewer's mobile device or other connected television device as the event progresses. The ecommerce environment on the user's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale can be revealed, wherein the revealing is rendered to the user. The user can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In some embodiments, the website container can display the virtual product cart while the synthesized video segment plays. The virtual product cart can cover a portion of the synthesized video segment while it plays.

In embodiments, users of the ecommerce website can receive invitations to one or more immediate livestreams as they navigate and interact with the website. The notifications of livestream events can be received by the user by email, text message, video message, and so on directly on the ecommerce website or by separate applications running on the user mobile device. As the user continues to participate in immediate livestream events, the virtual product cart can accumulate products selected for purchase. The user can choose to complete the purchase of selected products at the end of each livestream event, or at the end of their website session.

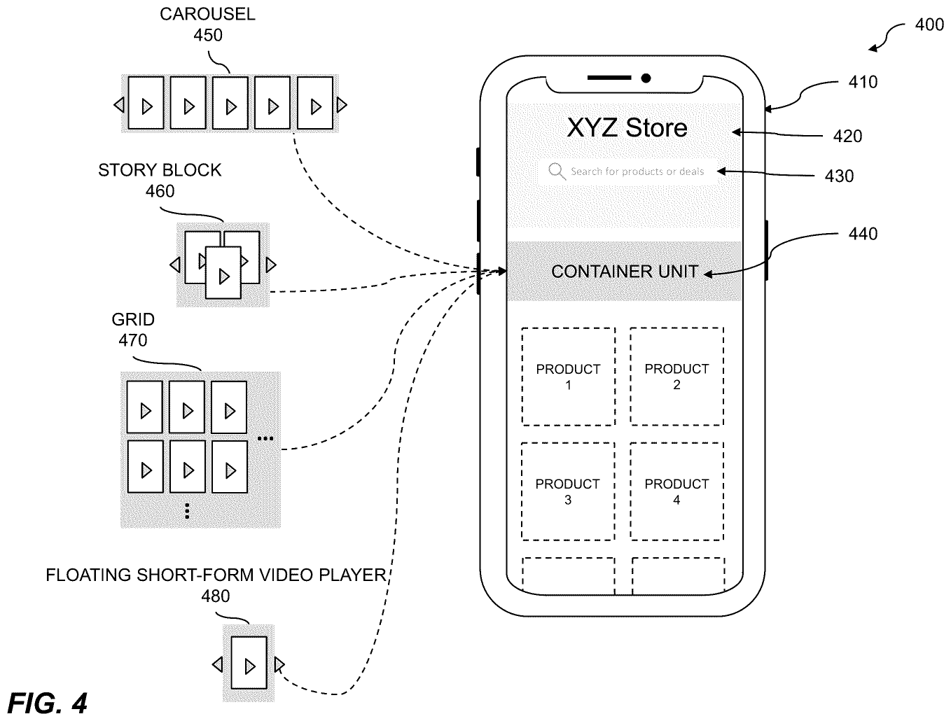

FIG. 4 is an infographic of a container unit. In embodiments, a search for products for sale, short-form videos, or related topics can be initiated by a user on a webpage. The search request can be captured by one or more processors and can be used to select one or more short-form videos from a library. A container unit can be inserted into the user webpage and can be populated with one or more of the selected short-form videos. In some embodiments, the container unit can be configured in different ways to present the short-form videos to the user. The size and resolution options of the display being used, user preferences, applications available on the user device, and other factors can contribute to the selection of the container unit configuration to be used.

The infographic 400 includes a device 410 capable of displaying an internet browser webpage 420. In embodiments, the webpage can be used to initiate a search 430 for products, short-form videos, or related information. The search can be captured by one or more processors and can be used to select short-form videos that satisfy the user search criteria. As the short-form videos are selected, a container unit 440 can be inserted into the user webpage 420 that initiated the search. In some embodiments, the container unit 440 can be arranged in different ways depending on the frame or player widget selected for use. A widget is an application or a component of an interface to an application, which enables a user to perform a function or access a service. In infographic 400, the widgets can be used to populate a container unit 440 with short-form videos selected from a library of short-form videos on an ecommerce website. The widgets can allow a user to select videos within the container unit 440 to be played or bypassed in favor of other short-form videos appearing in the container unit. The widgets can also be used to display text information such as questions or polls so that the user can interact with the video and respond to the questions or polls at the same time. The responses can be used to evaluate user engagement with the videos and capture trigger events to be used along with the video itself.

In some embodiments, the container unit can be configured to display the short-form videos in a carousel arrangement using a carousel frame widget. A carousel frame widget 450 inserts a set of related containers within a primary container, each populated by a single related short-form video in a left-to-right rotating arrangement. A carousel frame widget 450 allows multiple selected videos to be placed on the website simultaneously. In some embodiments, a slider with arrows that appear at the side of each video can be included. A simple selection bar or thumbnails of the short-form videos can appear underneath the primary viewing frame so that the user can move from one video to the next as desired. Timers can be built into the widget so that total viewing time, time elapsed, order of videos selected, etc. can be recorded and used as part of the engagement calculation.

In some embodiments, a story block frame widget 460 can be used to display short-form videos selected from a library of short-form videos. Story blocks are stock-published video footage, templates, music, and photo content available for download from vendors. A story block frame widget 460 populates a container with one or more story block videos from a particular vendor. The short-form videos can overlay one another, with the first video appearing on top. The order in which the videos appear within the story block frame can be used to communicate a story or message to the user in a particular order. In some embodiments, the user can select a particular video in the sequence to be viewed. The user can skip ahead, step back, or stop the story at any point. In some embodiments, short-form videos from the library of short-form videos can be added to the set of story block videos from a vendor. As trigger events for the short-form videos are captured and used to re-sort, replace, or remove videos within the story block frame 460, the story or message being communicated by the videos can be shaped or refined by the user. Timers can be built into the widget so that total viewing time, time elapsed, order of videos selected, etc. can be recorded and used as part of the trigger event information.

In some embodiments, a grid frame widget 470 can be used to configure the container unit 440. A grid frame widget allows elements, including short-form videos, to be placed in specific locations within the container using standardized row and column references. Header information, color schemes, company logos, etc., can thus be placed into the container unit in specific locations along with the selected short-form videos. The placement of the immediate livestream can be made in the container unit using the same row and column references. In some embodiments, the short-form video with the highest engagement score can appear in the upper left corner, followed by the second highest engagement score video appearing on the same row immediately to the right of the first video, and so on. Depending on the size of the display being used and the number of short-form videos selected, the user can simultaneously view several rows and columns of videos in thumbnail size. This arrangement allows the user to select videos to view in any order desired, giving the engagement metric calculation opportunity for additional refinement as the short-form videos are compared head to head. As with the other container unit widgets, timers can be built into the widget so that total viewing time, time elapsed, order of videos selected, etc. can be recorded and used as part of the trigger event information.

In some embodiments, a floating short-form video player widget 480 can be used to display the videos selected from a short-form video library. A floating video player widget 480 is a video player program that runs entirely within the container unit 440 without affecting the displayed main webpage. The container unit “floats” on top of the originating website page so that no format or content disruption occurs. In embodiments, one short-form video at a time is visible in the floating video player 480 frame. The advantage to the user is that the container unit frame can be placed anywhere on the display of the device, allowing the user flexibility as to when to view the short-form videos in relation to other elements appearing in the display. In some embodiments, movement of the floating video player on the display can contribute to the trigger event information. As with the other container unit widgets, timers can be built into the widget so that total viewing time, time elapsed, order of videos selected, etc. can be recorded and used as part of the trigger events.

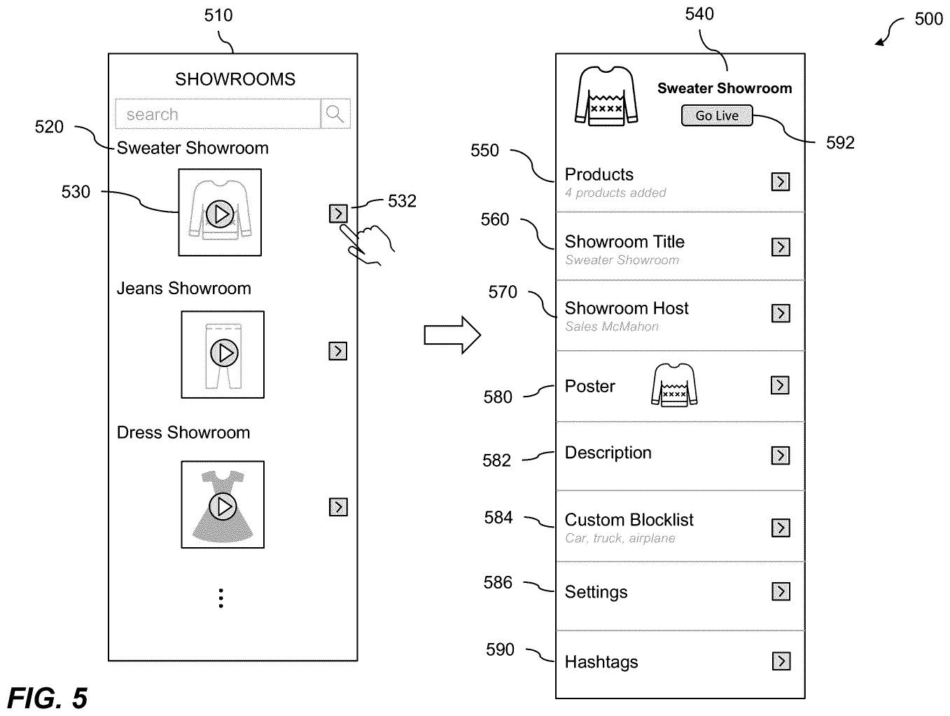

FIG. 5 illustrates editing an immediate livestream. As noted above and throughout, an immediate livestream can be created based on groups of ecommerce website users who are interested in the same or similar products, product types, or brands offered for sale on the website. Interest in products is measured using trigger events that are generated as the website users navigate and use the website pages. The groups of users are identified by a machine learning model that is updated as trigger events are recorded. The creation of the immediate livestream includes the product or products for sale associated with the group of users identified by the machine learning model. A sales representative for the ecommerce website is notified of the creation of the immediate livestream. The notification can be accomplished through email, text, voicemail, and so on. The notification can be sent to an internet-connected workstation or mobile device used by the sales representative. The sales representative can select a specific immediate livestream from a list of immediate livestreams that were created.

After selecting a specific immediate livestream, the sales representative can access the livestream through a back-office interface that allows the representative to schedule the start time of the livestream, notify users in the identified group of users of the start time of the livestream, create a countdown timer for the livestream start time, and so on. The back-office interface can be used to view and edit the livestream, including adding products to be offered for sale during the livestream. The illustration 500 includes a list of product showrooms 510. A “product showroom” is another term for an immediate livestream. The showrooms include products offered for sale on the ecommerce website that were associated with the group of users identified by a machine learning model. For example, in the illustration 500, the list of showrooms 510 includes several types of clothing showrooms, including a sweater showroom 520, jeans showroom, and dress showroom. Each showroom includes an image representing the immediate livestream that was created, which is associated with the products listed in each showroom category. In the illustration 500, the sweater showroom 520 includes an image that represents the immediate livestream 530, which includes sweaters offered for sale, on the ecommerce website, that were associated with a group of users identified by the machine learning model as interested in sweaters. A click button 532 appears to the side of each showroom in the list. The click button allows the sales representative to view details related to the selected showroom and make changes to the products included in the showroom.

The illustration 500 includes a detail screen of products and settings related to a specific showroom selected by a sales representative. The detail screen includes the title of the selected showroom 540. The detail screen also includes a list of products 550 that are included in the selected showroom. In FIG. 5, the detail screen for the sweater showroom 540 is shown, with the list of products 550 for sale in that category. A click button at the side of the list of products 550 allows the sales representative to add or remove products to the list of items made available for sale in the livestream. For instance, a single sweater from the sweater showroom 540 can be identified by the machine learning model as the basis for creating an immediate livestream when a group of website users generates trigger events related to the specific sweater. The sales representative who selects the related showroom can view the identified sweater using the sweater showroom list and select additional sweaters that are similar in look, are made by the same brand, come in different colors, etc. As more products are added, the product heading can include a counter to indicate the number of additional sweaters selected by the sales representative. In the illustration 500, the notice “4 products added” is shown beneath the “Products” title.

The illustration 500 includes configuration and display options for the items in each showroom. The sales representative can change the showroom title 560 and display or edit their name as showroom host 570. The product image used to represent the showroom can be changed to a different item in the category 580. A description of the showroom can be added or edited 582. The sales representative can also add a custom blocklist 584 to prevent the livestream user from moving to an unrelated page of the ecommerce website, the website of the brand or manufacturer of the product, and so on. Some products are made exclusively for specific vendors or sales outlets and do not appear on the websites of the manufacturer. Settings 586 related to the specific showroom can be edited. Background colors, sizes of images and text, coupons offered to the group of users, and/or sale indicators, etc. can be changed or updated. Hashtags 590 related to specific products or to the product showroom can be added or edited as well.

The illustration 500 includes a “Go Live” button 592 to save changes made to a showroom and to make the showroom available to be viewed by the group of users as a livestream. The sales representative can make changes to additional showrooms in order to add a broader selection of products based on the knowledge of the representative and sales goals of the ecommerce website. The settings 586 can also be used to select a start time for the immediate livestream, generate notices to the group of users, and/or generate a countdown clock prior to the start of the livestream.

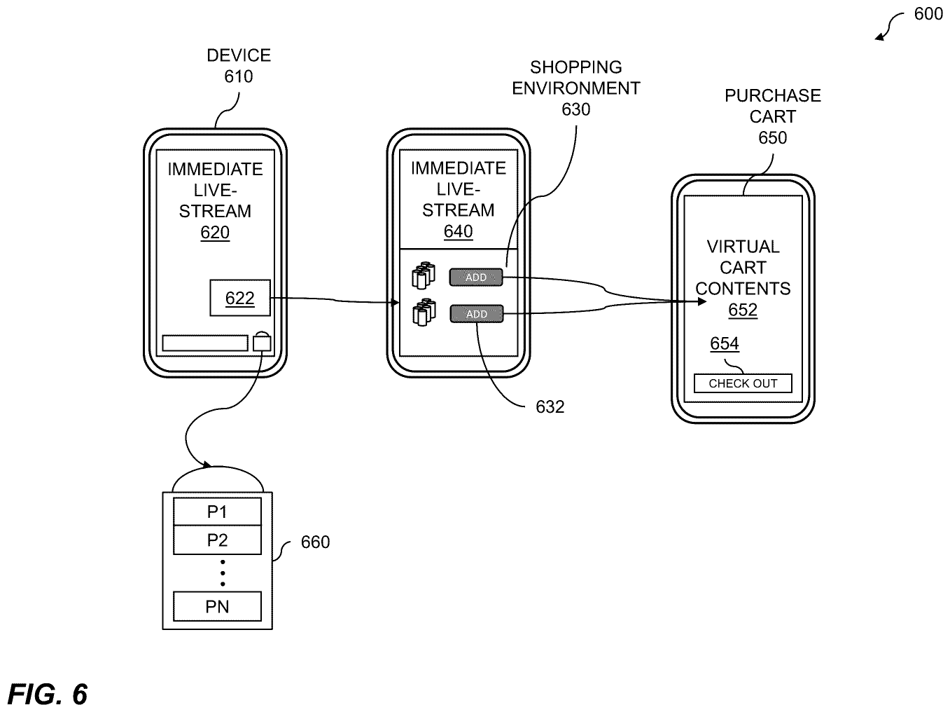

FIG. 6 is an example of an ecommerce purchase. As described above and throughout, an immediate livestream can be rendered to one or more viewers. The immediate livestream can highlight one or more products available for purchase. An ecommerce purchase can be enabled during the rendering of the immediate livestream using an in-frame shopping environment. The in-frame shopping environment can allow internet-connected television (CTV) viewers to buy products and services during the rendering of the immediate livestream. The rendering can include an on-screen product card that can be viewed on a CTV device and a mobile device. The in-frame shopping environment or window can also include a virtual purchase cart that can be used by viewers as the immediate livestream plays.

The example 600 includes a device 610 displaying an immediate livestream 620. In embodiments, the immediate livestream 620 can be viewed in real time or replayed at a later time. The device 610 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the immediate livestream 620 on the device 610 can be accomplished using a browser or another application running on the device.

The example 600 includes generating and revealing a product card 622 on the device 610. In embodiments, the product card represents at least one product available for purchase while the immediate livestream plays. Embodiments can include inserting a representation of a product for sale into the on-screen product card. A product card is a graphical element such as an icon, thumbnail picture, thumbnail video, symbol, or other suitable element that is displayed in front of the livestream. The product card is selectable via a user interface action such as a press, swipe, gesture, mouse click, verbal utterance, or other suitable user action. The product card 622 can be inserted when the immediate livestream is visible to the user. When the product card is invoked, an in-frame shopping environment 630 is rendered over a portion of the livestream while the livestream continues to play. This rendering enables an ecommerce purchase 632 by a user while preserving a continuous video playback session. In other words, the user is not redirected to another site or portal that causes the livestream playback to stop. Thus, viewers are able to initiate and complete a purchase completely inside of the video playback user interface, without being directed away from the currently playing video. Allowing the immediate livestream to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The example 600 includes rendering an in-frame shopping environment 630 enabling a purchase of the at least one product for sale by the viewer, wherein the ecommerce purchase is accomplished within the immediate livestream window 640. In embodiments, the rendering of the immediate livestream can include a real-time playing of the immediate livestream or a prerecorded video segment. The enabling can include revealing a virtual purchase cart 650 that supports checkout 654 of virtual cart contents 652, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 660 are purchased via product cards during the immediate livestream, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

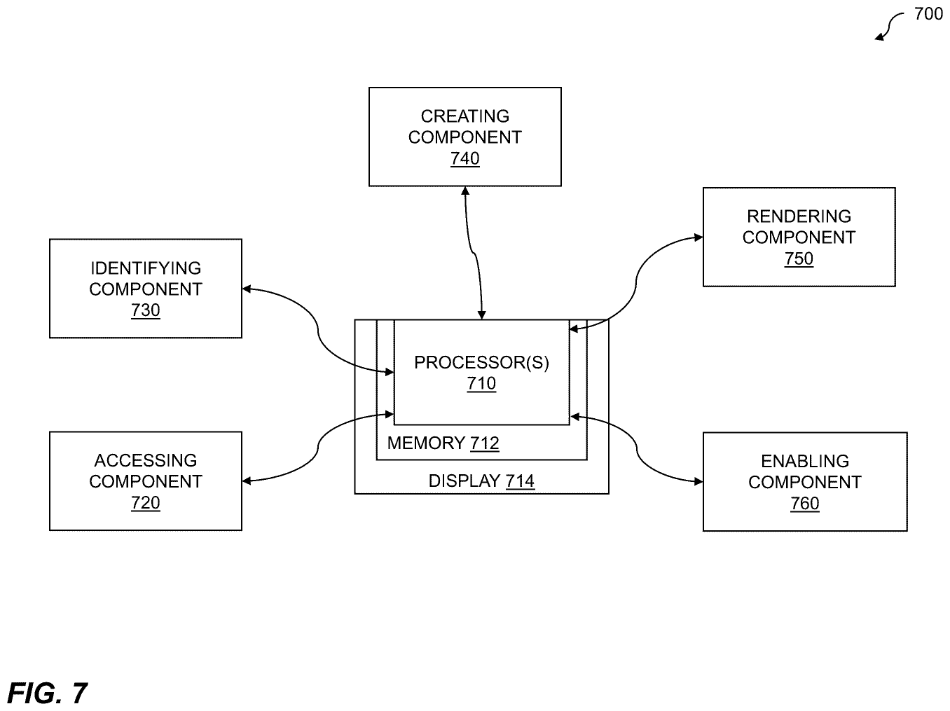

FIG. 7 is a system diagram for immediate livestreams in a short-form video ecommerce environment. The system 700 can include one or more processors 710 coupled to a memory 712 which stores instructions. The system 700 can include a display 714 coupled to the one or more processors 710 for displaying data, video streams, videos, intermediate steps, instructions, and so on. In embodiments, one or more processors 710 are coupled to the memory 712 where the one or more processors, when executing the instructions which are stored, are configured to: access a website, wherein the website includes a plurality of products for sale, wherein the website includes a container unit comprising one or more short-form videos, and wherein the website is viewed by a plurality of users; identify one or more groups of users from the plurality of users, wherein each of the one or more groups includes users with an interest in one or more products from the plurality of products for sale; create, for each group of the one or more groups of users, an immediate livestream, wherein a number of users within each group is higher than a threshold value, and wherein the immediate livestream includes the one or more products; render, to each group of the one or more groups of users, the immediate livestream within the container unit on the website; and enable, within the immediate livestream that was rendered, an ecommerce purchase of the one or more products.

The system 700 includes an accessing component 720. The accessing component 720 can include functions and instructions for accessing a website, wherein the website includes a plurality of products for sale, wherein the website includes a container unit comprising one or more short-form videos, and wherein the website is viewed by a plurality of users. The website can be an ecommerce site for a single vendor or brand, a group of businesses, a social media platform, and so on. In embodiments, the website can be displayed on a portable device. The portable device can be an Over-the-Top (OTT) device such as a mobile phone, laptop computer, tablet, or pad. The accessing of the website can be accomplished using a browser or another application running on the device.

The container unit comprises a story block, carousel, floating player, or grid. A container unit is a component of a web server that interacts with computer programs, called servlets, that are designed to interact with users, other programs, or other servers. The container unit manages the lifecycle of the servlets, maps URLs to particular servlets, confirms access rights to URLs, and so on. Story blocks are servlets that access stock-published video footage, templates, music, and/or photo content available for download from websites or libraries of short-form videos. A carousel is a set of related containers within a primary container, each populated by a single related short-form video. A carousel container allows multiple videos selected by the user to be placed on the website in order of selection. A floating player is a video player that runs entirely within the container unit without affecting the displayed main webpage. The container unit “floats” on top of the host website page so that no format or content disruption occurs. A grid container allows videos to be placed in specific locations within the container using standardized row and column references. Additional information, including header information, color schemes, company logos, etc., can also be placed into the container unit in specific locations. The container unit can be populated by the at least one selected short-form video from the website. The placement of the immediate livestream can be made in the container unit using the same row and column references. In embodiments, the populating of the container unit can be accomplished dynamically. Dynamic populating allows the container unit generated on the website to play or change the one or more selected short-form videos without refreshing the website page that sent the search request.

The system 700 includes an identifying component 730. The identifying component 730 can include functions and instructions for identifying one or more groups of users from the plurality of users, wherein each of the one or more groups includes users with an interest in one or more products from the plurality of products for sale. In embodiments, the identifying is based on machine learning. Machine learning models can be used to cluster or separate data points into a number of groups so that data points in the same group are more similar to other data points in the same group and dissimilar to the data points in other groups. There are several machine learning algorithms available to evaluate data points and generate groups of users with similar trigger events, including K-means; DBSCAN; Gaussian mixture; Balance Iterative, Reducing and Clustering using Hierarchies (BIRCH); affinity propagation; and so on. The result of using the machine learning model clustering algorithms is to identify groups of viewers on the website in which each group is interested in the same product, type of product, or brand. These groups can be used as the basis for creating an immediate livestream that can offer the associated products for sale to the users in the associated group.

The identifying is based on a trigger event, wherein the trigger event includes watching, by the one or more groups of users, at least one short-form video related to the one or more products; wherein the trigger event includes placing, by the one or more groups of users, the one or more products into a virtual cart; wherein the trigger event includes spending a length of time on a webpage within the website by the one or more groups of users; and wherein the trigger event includes viewing a comparison of at least two products for sale by the one or more groups of users. A trigger event is an action or occurrence on a website that can indicate user interest in the contents of a webpage or in products displayed on a webpage. The trigger events can include watching, by the one or more groups of users, at least one short-form video related to the one or more products; placing, by the one or more groups of users, the one or more products into a virtual cart; spending a length of time on a webpage within the website by the one or more users; viewing a comparison of at least two products for sale by the one or more groups of users; and so on. Additional trigger events can include scrolling to the bottom or end of a webpage, clicks leading to associated webpages, questions or comments made by users regarding a product or brand, website searches for related products, and so on. As each trigger event is recorded, metadata associated with the user generating the trigger event, including hashtags, purchase history, favorites, and so on, can also be collected. The metadata can include demographic information as well. In some embodiments, the trigger events can be weighted so that some events are more significant in the creation of user groups than others. For instance, clicks on specific products can be given a higher weight than general questions about a product brand or broad category of products. The trigger event and user data can be submitted to a database that can be accessed by the machine learning model.

The system 700 includes a creating component 740. The creating component 740 can include functions and instructions for creating, for each group of the one or more groups of users, an immediate livestream, wherein a number of users within each group is higher than a threshold value, and wherein the immediate livestream includes the one or more products.

In embodiments, the immediate livestream includes highlighting the one or more products for sale to the user, and the creating of the immediate livestream further comprising representing the one or more products for sale in an on-screen product card. The livestream host can highlight products and services for sale during the livestream event. The host can demonstrate, endorse, recommend, and otherwise interact with one or more products for sale. The host can also interact with one or more users in the group, responding to questions and comments, supplying additional information, showing short-form videos, generating multiple-choice queries, and so on. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale can be revealed, wherein the revealing is rendered to the viewer.

In embodiments, the immediate livestream includes an interactive overlay. The interactive overlay can include a multiple-choice selection. In embodiments, the interactive overlay can include a call to action. In other embodiments, the interactive overlay can include a lead generation prompt. In further embodiments, the interactive overlay can include a question card or a poll. A call to action (CTA) is an invitation to a website user to perform a desired action. A lead generation prompt includes a small set of questions for a user to allow a sales representative to follow up with additional information regarding a product or service. User responses to questions or comments appearing in the interactive overlay can be recorded; choices of additional short-form videos can be presented and selected; options to purchase products or services portrayed in the video can be chosen; options to replay a short-form video, go back to a previous video, or stop watching videos can be selected; and so on. The interactions can be forwarded to the machine learning model in order to learn and update associations to one or more products made by users. An ecommerce environment can be rendered with the interactive overlay so that the user can select items to be purchased immediately or at a later time. In embodiments, the threshold value is programmable.

In embodiments, the creating component 740 includes connecting a host to the livestream. The immediate livestream host can be a sales associate of the website. The creating includes notifying the host of the immediate livestream. The sales associate can be someone who is knowledgeable about the one or more products, an employee or owner of an associated store in a physical location, an employee or owner of an online store, a third-party salesperson, and so on. The notification can be accomplished by text to a chat application, email, voicemail, or electronic messages to an application running on a mobile device.

The system 700 includes a rendering component 750. The rendering component 750 can include functions and instructions for rendering, to each group of the one or more groups of users, the immediate livestream within the container unit on the website. The rendering can include displaying decoded video frames on an electronic display, such as a screen of a smartphone or tablet, laptop or desktop computer, PDA, and so on. The immediate livestream can be rendered outside of the container unit on the website, or can be rendered to occupy the entire screen. The immediate livestream can be delivered from a web server hosting the ecommerce website. The delivery can be via any suitable network protocols, including, but not limited to, TCP, UDP, HTTP Live Streaming (HLS), Real-Time Messaging Protocol (RTMP), Web Real-Time Communications (WebRTC), Secure Reliable Transport (SRT), and/or other suitable protocols. The livestream can be delivered via unicast, multicast, or broadcast. In many cases, multicast is considered a one-to-many and many-to-many communication protocol that reduces network traffic when transmitting large amounts of data. Bandwidth optimization can occur because it delivers one single version of a data file, such as a livestream, to hundreds or thousands of users simultaneously. In embodiments, the rendering further comprises initiating, by the sales associate, the specific immediate livestream.

The system 700 includes an enabling component 760. The enabling component 760 can include functions and instructions for enabling, within the immediate livestream that was rendered, an ecommerce purchase of the one or more products. In embodiments, the enabling the ecommerce purchase includes a virtual purchase cart. In other embodiments, the enabling component can further comprise displaying, within the immediate livestream, the virtual purchase cart. The virtual purchase cart can cover a portion of the immediate livestream. As mentioned above and throughout, the livestream host can highlight products and services for sale during the livestream event. The host can demonstrate, endorse, recommend, and otherwise interact with one or more products for sale. An ecommerce purchase of at least one product for sale can be enabled to the viewer, wherein the ecommerce purchase is accomplished within the livestream window. As the host interacts with and presents the products for sale, a product card can be included within a livestream shopping window. An ecommerce environment associated with the livestream event can be generated on the viewer's mobile device or other connected television device as the event progresses. The ecommerce environment on the viewer's mobile device can display the livestream event and the ecommerce environment at the same time. The mobile device user can interact with the product card in order to learn more about the product with which the product card is associated. While the user is interacting with the product card, the livestream event continues to play. Purchase details of the at least one product for sale can be revealed, wherein the revealing is rendered to the viewer. The viewer can purchase the product through the ecommerce environment, including a virtual purchase cart. The viewer can purchase the product without having to “leave” the livestream event. Leaving the livestream event can include having to disconnect from the event, open an ecommerce window separate from the livestream event, and so on. The livestream event can continue while the viewer is engaged with the ecommerce purchase. In embodiments, the livestream event can continue “behind” the ecommerce purchase window, where the virtual purchase window can obscure or partially obscure the livestream event. In some embodiments, the synthesized video segment can display the virtual product cart while the synthesized video segment plays. The virtual product cart can cover a portion of the synthesized video segment while it plays.

The system 700 can include a computer program product embodied in a non-transitory computer readable medium for video creation, the computer program product comprising code which causes one or more processors to perform operations of: accessing a website, wherein the website includes a plurality of products for sale, wherein the website includes a container unit comprising one or more short-form videos, and wherein the website is viewed by a plurality of users; identifying one or more groups of users from the plurality of users, wherein each of the one or more groups includes users with an interest in one or more products from the plurality of products for sale; creating, for each group of the one or more groups of users, an immediate livestream, wherein a number of users within each group is higher than a threshold value, and wherein the immediate livestream includes the one or more products; rendering, to each group of the one or more groups of users, the immediate livestream within the container unit on the website; and enabling, within the immediate livestream that was rendered, an ecommerce purchase of the one or more products.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,”“module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory);

an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video creation comprising:
accessing a website, wherein the website includes a plurality of products for sale, wherein the website includes a container unit comprising one or more short-form videos, and wherein the website is viewed by a plurality of users;
identifying one or more groups of users from the plurality of users, wherein each of the one or more groups includes users with an interest in one or more products from the plurality of products for sale;
creating, for each group of the one or more groups of users, an immediate livestream, wherein a number of users within each group is higher than a threshold value, and wherein the immediate livestream includes the one or more products;
rendering, to each group of the one or more groups of users, the immediate livestream within the container unit on the website; and
enabling, within the immediate livestream that was rendered, an ecommerce purchase of the one or more products.

2. The method of claim 1 wherein the identifying is based on a trigger event.

3. The method of claim 2 wherein the trigger event includes watching, by the one or more groups of users, at least one short-form video related to the one or more products.

4. The method of claim 2 wherein the trigger event includes placing, by the one or more groups of users, the one or more products into a virtual cart.

5. The method of claim 2 wherein the trigger event includes spending a length of time on a webpage within the website by the one or more groups of users.

6. The method of claim 2 wherein the trigger event includes viewing a comparison of at least two products for sale by the one or more groups of users.

7. The method of claim 1 wherein the identifying is based on machine learning.

8. The method of claim 1 further comprising inviting each group of the one or more groups of users to participate in the immediate livestream that was created.

9. The method of claim 8 further comprising scheduling a time for the immediate livestream to begin.

10. The method of claim 9 further comprising notifying users within each group of the one or more groups of the time for the immediate livestream to begin.

11. The method of claim 9 further comprising revealing a countdown timer as an overlay to the immediate livestream prior to a start of the immediate livestream.

12. The method of claim 1 further comprising selecting, by a sales associate, a specific immediate livestream from a list of the immediate livestreams that were created for each group of the one or more groups of users.

13. The method of claim 12 further comprising editing, by the sales associate, information pertaining to the specific immediate livestream.

14. The method of claim 13 further comprising adding, to the immediate livestream, other products for sale related to the one or more products for sale.

15. The method of claim 12 further comprising initiating, by the sales associate, the specific immediate livestream.

16. The method of claim 1 wherein the enabling the ecommerce purchase includes a virtual purchase cart.

17. The method of claim 16 further comprising displaying, within the immediate livestream, the virtual purchase cart.

18. The method of claim 17 wherein the virtual purchase cart covers a portion of the immediate livestream.

19. The method of claim 1 wherein the immediate livestream includes highlighting the one or more products for sale to the user.

20. The method of claim 19 further comprising representing the one or more products for sale in an on-screen product card.

21. The method of claim 1 wherein the immediate livestream includes an interactive overlay.

22. The method of claim 1 wherein the threshold value is programmable.

23. The method of claim 1 wherein the container unit comprises a story block, carousel, floating player, or grid.

24. A computer program product embodied in a non-transitory computer readable medium for video creation, the computer program product comprising code which causes one or more processors to perform operations of:
accessing a website, wherein the website includes a plurality of products for sale, wherein the website includes a container unit comprising one or more short-form videos, and wherein the website is viewed by a plurality of users;
identifying one or more groups of users from the plurality of users, wherein each of the one or more groups includes users with an interest in one or more products from the plurality of products for sale;
creating, for each group of the one or more groups of users, an immediate livestream, wherein a number of users within each group is higher than a threshold value, and wherein the immediate livestream includes the one or more products;
rendering, to each group of the one or more groups of users, the immediate livestream within the container unit on the website; and
enabling, within the immediate livestream that was rendered, an ecommerce purchase of the one or more products.

25. A computer system for video creation comprising:
a memory which stores instructions;
one or more processors coupled to the memory wherein the one or more processors, when executing the instructions which are stored, are configured to:
access a website, wherein the website includes a plurality of products for sale, wherein the website includes a container unit comprising one or more short-form videos, and wherein the website is viewed by a plurality of users;
identify one or more groups of users from the plurality of users, wherein each of the one or more groups includes users with an interest in one or more products from the plurality of products for sale;
create, for each group of the one or more groups of users, an immediate livestream, wherein a number of users within each group is higher than a threshold value, and wherein the immediate livestream includes the one or more products;
render, to each group of the one or more groups of users, the immediate livestream within the container unit on the website; and
enable, within the immediate livestream that was rendered, an ecommerce purchase of the one or more products.
